(19) United States
(12) Patent Application Publication
(10) Pub. No.: US 2012/0099833 A1
(43) Pub. Date: Apr. 26, 2012

(54) RECORDING/REPRODUCING APPARATUS AND METHOD OF CONTROLLING AN APPARATUS CONNECTED BETWEEN RECORDING/REPRODUCING APPARATUS AND VIDEO DISPLAY APPARATUS

(75) Inventor: Hiroaki Oomori, Fukaya-shi (JP)

(73) Assignee: KABUSHIKI KAISHA TOSHIBA, Tokyo (JP)

(21) Appl. No.: 13/222,773

(22) Filed: Aug. 31, 2011

(30) Foreign Application Priority Data
Oct. 22, 2010 (JP) 2010237450

(51) Int. Cl. H04N 5/775; G06F 1/26

(52) U.S. Cl. 386/230; 713/310; 386/E05.07

(57) ABSTRACT

According to one embodiment, a recording/reproducing apparatus including, a network controller configured to acquire a program or data via a network, a signal processing module configured to transmit and receive a program or data or a control signal using a bidirectional communication, and a determination module configured to determine that each of a connected apparatus and an external apparatus are an apparatus, which is capable of turning off the power according to a power-off instruction if the connected apparatus and the external apparatus accept the power-off instruction from the signal processing module when the signal processing module is connected to the external device via an apparatus connected by a bidirectional interface, and to notify the determination.

### CROSS-REFERENCE TO RELATED APPLICATIONS

This application is based upon and claims the benefit of priority from Japanese Patent Application No. 2010-237450, filed Oct. 22, 2010; the entire contents of which are incorporated herein by reference.

### FIELD

Embodiments described herein relate generally to a recording/reproducing apparatus, which is connected by means of a bidirectional interface, and to a method of controlling an apparatus connected between recording/reproducing apparatus and video display apparatus.

### BACKGROUND

A High-definition Digital Media Interface (HDMI) is widely used as a bidirectional communication interface.

Moreover, a recording/reproducing apparatus is connected to a video display apparatus via a local area network (LAN) in addition to a connection using HDMI. For example, it is possible to reproduce content held in a recording/reproducing apparatus, that is, video and audio (generally referred to as a program) using a personal computer (PC).

In the connection using HDMI, HDMI Ethernet Channel (HEC) version 1.4 has been established following the Consumer Electronics Control (CEC) standard established subsequent to HDMI. According to HEC, a control signal is transferable via Audio Return Channel (ARC) version 1.4 and Ethernet (registered trademark).

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the invention.

FIG. 1 is an exemplary diagram showing a example of a configuration of a system according to an embodiment;

FIGS. 2A, 2B, 2C and 2D are exemplary diagrams each showing an example of a signal flow according to an embodiment;

FIG. 3 is an exemplary diagram showing a method of controlling an apparatus according to an embodiment;

FIG. 4 is an exemplary diagram showing an example of a method of controlling an apparatus according to an embodiment;

FIG. 5 is an exemplary diagram showing an example of a configuration of a television receiver according to an embodiment according to an embodiment; and

FIG. 6 is an exemplary diagram showing an example of a configuration of a recorder according to an embodiment.

### DETAILED DESCRIPTION

Various embodiments will be described hereinafter with reference to the accompanying drawings. In general, according to one embodiment, a recording/reproducing apparatus comprising: a network controller configured to acquire a program or data via a network; a signal processing module configured to transmit and receive a program or data or a control signal using a bidirectional communication; and a determination module configured to determine that each of a connected apparatus and an external apparatus are an apparatus, which is capable of turning off the power according to a power-off instruction if the connected apparatus and the external apparatus accept the power-off instruction from the signal processing module when the signal processing module is connected to the external device via an apparatus connected by a bidirectional interface, and to notify the determination.

Embodiments will now be described hereinafter in detail with reference to the accompanying drawings.

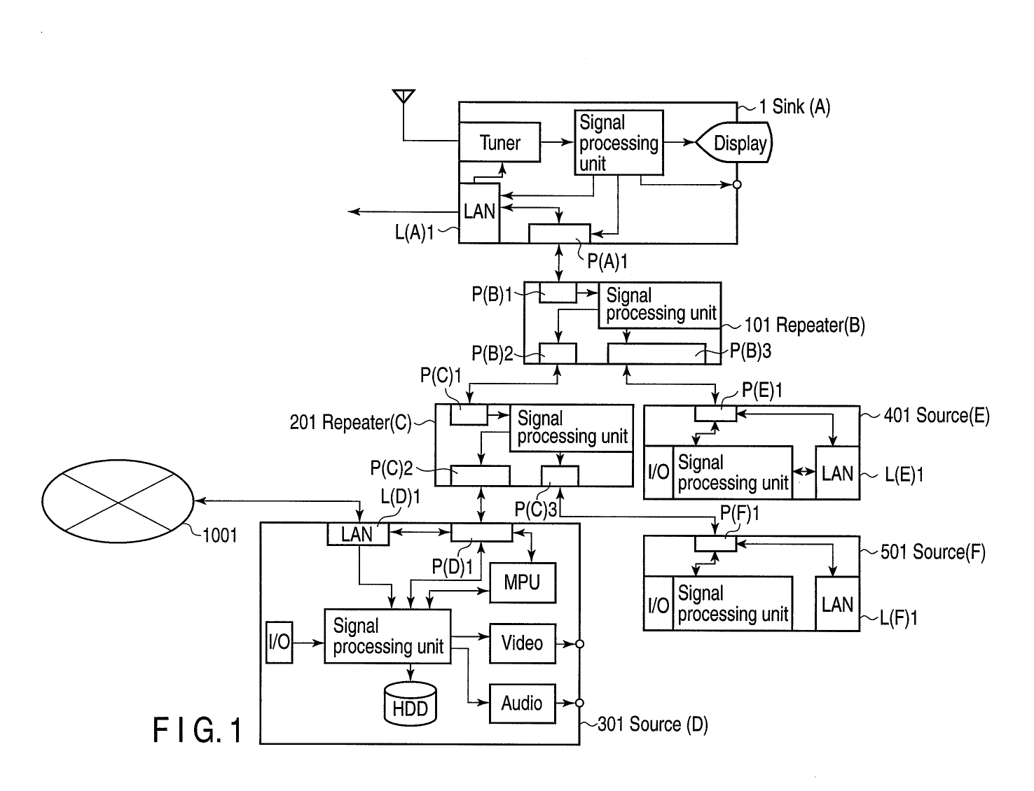

FIG. 1 is a view showing one example of connecting a plurality of apparatuses (repeaters) connected in order between a video display apparatus (e.g., television receiver, hereinafter, referred to as TV receiver) and a recording/reproducing apparatus (e.g., recorder) to which this embodiment is applied by means of a bidirectional communication interface (e.g., a LAN cable or an HDMI cable; in this case, a LAN cable is used with respect to a LAN [network], and an HDMI cable with respect to an interface conforming to the High-definition Digital Media Interface [HDMI] standard). The element and configuration or function described below may be realized by hardware, and may be realized by software using a microcomputer (processor, CPU).

A sink apparatus (A) 1, for example, a television (TV) receiver is connected in order with the following apparatuses. One is a first repeater apparatus (B) 101. Another is a second repeater apparatus (C) 201. Another is a first source apparatus (D) 301, for example, a recorder. Another is a second source apparatus (E) 401, which is connected to the first repeater apparatus (B) 101 in parallel with the second repeater apparatus (C) 201. Another is a third source apparatus (F) 501, which is connected to the second repeater apparatus (C) 201 in parallel with the first source apparatus (D) 301.

Namely, FIG. 1 shows a state that the TV receiver (sink apparatus (A)) 1 is connected in order with first and second repeater apparatuses (B) 101 and (C) 201, and the second repeater apparatus (C) 201 is connected with the first source apparatus (D) 301.

According to the connection shown in FIG. 1, the second repeater apparatus (C) 201 and the first repeater apparatus (B) 101 are connected in order from the first source apparatus (D), that is, the recorder 301 toward the TV receiver 1. Namely, the second and first repeater apparatuses (C) 201 and (B) 101 are connected in series between the recorder 301 and the TV receiver 1.

The TV receiver (sink apparatus (A)) 1 includes a tuner, a signal processing unit, a LAN controller L(A)1 and an HDMI Ethernet Channel (HDMI-HEC) version 1.4 port P(A)1, at least. Specifically, the tuner receives and selects a program. The signal processing unit outputs a video of the program selected by the tuner to a display unit so that the display unit displays the video, and outputs an audio output to an audio output terminal. The LAN controller L(A)1 acquires a program from a network, for example the Internet 1001. The HDMI-HEC port P(A)1 is connected to the LAN controller L(A)1, and inputs a program (data) acquired via the LAN controller L(A)1, and further, makes an exchange of a program (data) via the LAN controller L(A)1 with an external apparatus externally connected.

In this case, the LAN controller L(A)1 may be controlled by the signal processing unit, and may include an independent controller (sub-controller) as the LAN controller. Moreover, the HDMI-HEC port P(A)1 is mainly controlled by the signal processing unit. The port P(A)1 may be provided with an independent controller (sub-controller) for HDMI control. Of course, the LAN controller L(A)1 and port P(A)1 are controllable by means of an integrated sub-controller. The strict boundary as the controller is optionally set by a provider of the apparatus.

The first and second repeater apparatuses (B) 101 and (C) 201 includes first HDMI ports P(B)1, P(C)1, second HDMI ports P(B)2, P(C)2, and third HDMI ports P(B)3, P(C)3, at least, respectively. The first HDMI ports P(B)1 and P(C)1 are used as an input side (output side) of signal and data supplied via an HDMI cable. The second HDMI ports P(B)2 and P(C)2 are used as an output side (input side) of signal and data supplied via an HDMI cable. The third HDMI ports P(B)3 and P(C)3 are used as an output side (input side) of signal and data supplied via an HDMI cable. Each port is connected to a signal processing unit to execute a predetermined operation according to control signals provided by the sink apparatus (A)1 and first source apparatus (D) 301.

The first source apparatus (D), that is, the recorder 301 includes a main processing unit (MPU) (processor) functioning as a main controller, a signal processing unit, an input/output unit (I/O port), an HDMI port P(D)1 and a LAN controller L(D)1, at least. Specifically, the signal processing unit separates video and audio signals, and executes a signal processing such as decoding and encoding. The input/output unit (I/O port) receives externally input video and audio, and outputs a control signal as the necessity arises. Preferably, the HDMI port P(D)1 is conforming to HDMI-HEC, which makes an exchange of a program (data) acquired from the Internet 1001 via the LAN controller L(D)1.

The output of the signal processing unit is recorded in a hard disk drive (HDD), for example. Moreover, the output of the signal processing unit is output to a video output and an audio output.

On the other hand, control, video and audio signals input/output via the HDMI port P(D)1 are supplied to the signal processing unit. In this case, the control, video and audio signals input/output via the HDMI port P(D)1 include a program (data) acquired via the LAN controller L(D)1.

Although the details are omitted, for example, second and third source apparatuses (E) 401 and (F) 501 are defined as a recorder as well as the first source apparatus (D) 301. In this case, the forgoing second and third source apparatuses (E) 401 and (F) 501 includes an I/O port used for signal input and output, a signal processing unit, HDMI ports P(E)1, P(F)1, and LAN controllers L(E)1, L(F)1, at least, respectively. Specifically, the HDMI ports P(E)1 and P(F)1 are used as an input side (output side) of signal and data via an HDMI cable. The LAN controllers L(E)1 and L(F)1 are connected to individual HDMI ports P(E)1 and P(F)1, and are connectable with the Internet 1001 to acquire a program from there.

The sink apparatus includes the TV receiver 1 shown in FIG. 1, a monitor or a projector.

The source apparatus includes the recorder (source apparatus (D)) 301 and a set-top box (STB) (in the wide sense, an external tuner; in the narrow sense, a connector for selecting a program supplied by a supplier connected by means of a wire).

The repeater apparatus includes an audio visual (AV) amplifier, a speaker (audio reproducer) or a selector or a distributor for a connection with a game player, for example.

According to the connection shown in FIG. 1, the first repeater apparatus (B) 101 is, for example, an audiovisual (AV) amplifier, and the second repeater apparatus (C) 201 is, for example, a selector.

Moreover, the HDMI functioning as a bidirectional communication interface has a version conforming to HDMI-Consumer Electronics Control (CEC). In this case, the sink apparatus is able to output a predetermined control signal to an optional apparatus included in a network (local area network [LAN]) or an optional apparatus connected by means of an HDMI cable conforming to HDMI-CEC. For example, the predetermined control signal is a start signal (wake-on-LAN [WOL] signal), which turns on the main power in a state that the main power is turned on, or an end signal, which turns off the main power from a state that the main power is turned on.

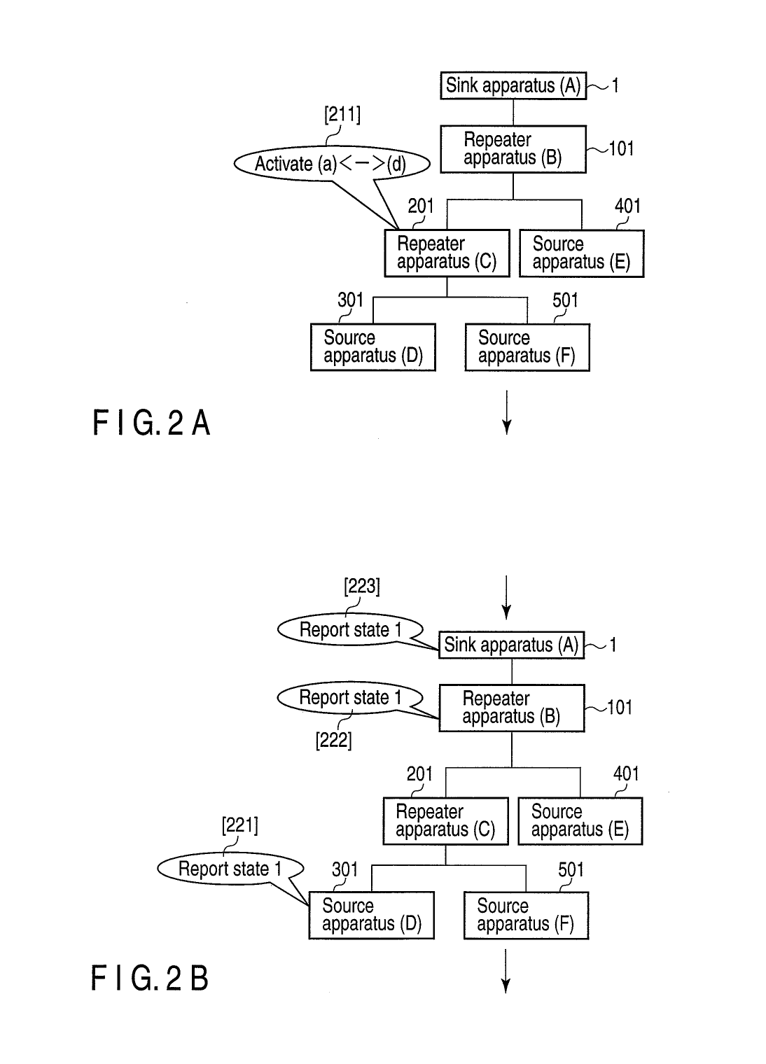

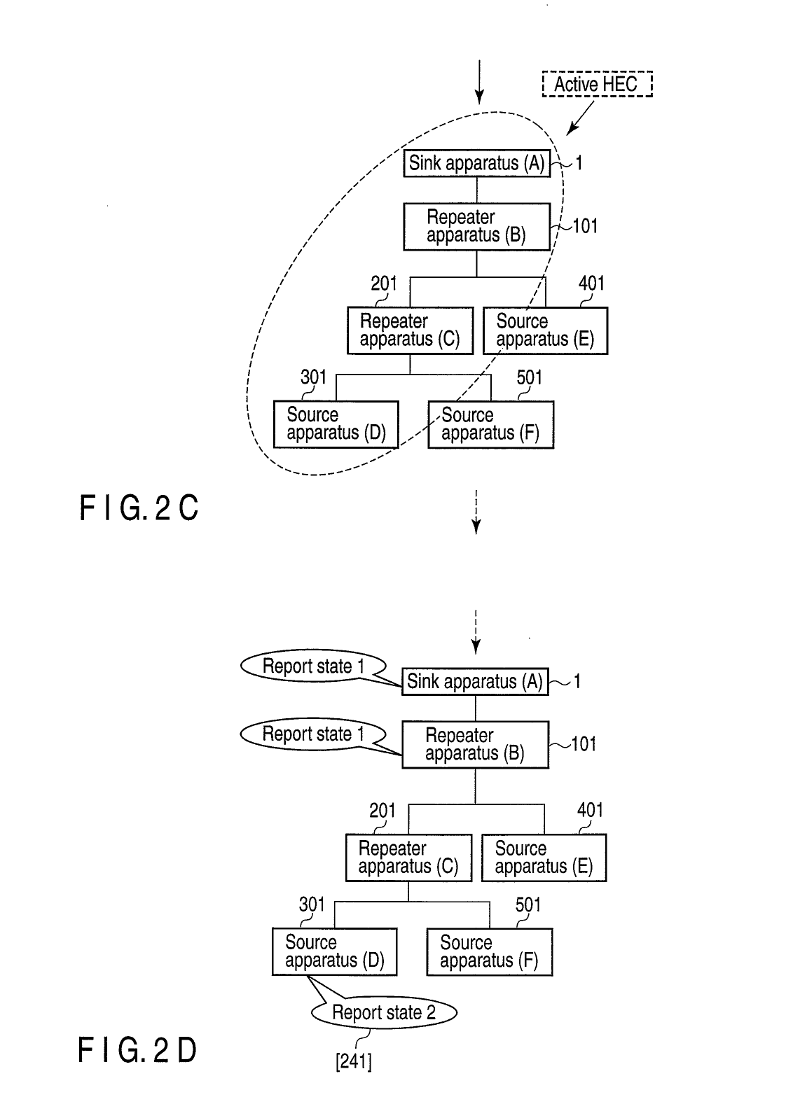

FIG. 2 is a view to explain the signal flow according to the connection shown in FIG. 1. First and second repeater apparatuses (B) 101 and (C) 201 are interposed between the TV receiver (sink apparatus (A)) 1 and the recorder (first source apparatus (D)) connected to the TV receiver 1. The first and second repeater apparatuses (B) 101 and (C) 201, that is, optional apparatuses connected in series on the way acquire HDMI Ethernet Channel (hereinafter referred simply to as HEC) information defined by HDMI version 1.4 by means of extended display identification data (EDID) and HDMI-CEC [a]. For example, the HEC information includes vendor (inherent information prepared by a maker of the apparatus), a model name and sink apparatus information.

Then, the second repeater apparatus (C) 201 transmits an “Activate A-D” (activate (A)<->(D)) command to obtain a connection conforming to HDMI version 1.4 between TV receiver (sink apparatus (A)) and recorder (first source apparatus (D)), that is, a state that Ethernet data is suppliable to HDMI-HEC (see FIG. 2A-[211]) [b].

When receiving the “Activate A-D” command transmitted by the second repeater apparatus (C) 201 in the above mentioned [b], the first source apparatus (D) 301 refers to HEC information of the second repeater apparatus (C) 201 acquired in the above mentioned [a]. Then, the first source apparatus (D) 301 determines whether or not the second repeater apparatus (C) 201 is an apparatus, which completed accepts a HEC end request (hereinafter, referred to as a deactivate request) command transmitted by the first source apparatus (D) 301 [c].

The determination [c] is made; as a result, the first source apparatus (D) 301 determines that the second repeater apparatus (C) 201 is an apparatus, which securely accepts a deactivate request. In this case, the first source apparatus (D) 301 transmits a report state 1, which means that it is transferable to an active state, with respect to the “Activate A-D” command transmitted by the second repeater apparatus (C) 201 in the above mentioned [b] (see FIG. 2B-[221]).

Conversely, the determination [c] is made; as a result, the first source apparatus (D) 301 determines that the second repeater apparatus (C) 201 is not an apparatus, which securely accepts a deactivate request. In this case, the first source apparatus (D) 301 transmits a report state 2, which means that it is not transferable to an active state, with respect to the “Activate A-D” command transmitted by the second repeater apparatus (C) 201 in the above mentioned [b] (see FIG. 2D-[241]) [d].

Therefore, according to the signal flow shown in FIG. 2B, it is determined that the second repeater apparatus (C) 201 is an apparatus, which securely accepts a deactivate request. In this case, the first source apparatus (D) 301 transmits a report state 1 [222]. Likewise, when determining that the sink apparatus (A)1 is an apparatus, which completed accepts a deactivate request, the first source apparatus (D) 301 transmits a report state 1 [223].

As described above, the first source apparatus (D) 301 detects (ascertains) the following matter based on HEC information acquired in the above mentioned [a]. Specifically, all repeater apparatuses (B) 101 and (C) 201 positioned between the first source apparatus (D) 301 and the sink apparatus (A)1 and the sink apparatus (A)1 are transferable to an active state with respect to the “activate A-D” command transmitted by the second repeater apparatus (C) 201 in the above mentioned [b]. In this case, active HEC can be built up (see FIG. 2C-[231]). Namely, the following condition is established with respect to the “activate A-D” command transmitted by the second repeater apparatus (C) 201 in the above mentioned [b]. Specifically, the first source apparatus (D) 301 transmits a report state 1 to each of the sink apparatus (A)1, optional repeater apparatuses (B) and (C) interposed between the sink apparatus (A)1 and the first source apparatus (D) 301. In this case, active HEC can be built up with respect to optional repeater apparatuses (B) and (C) interposed between the sink apparatus (A)1 and the first source apparatus (D) 301 (see FIG. 2C-[231]).

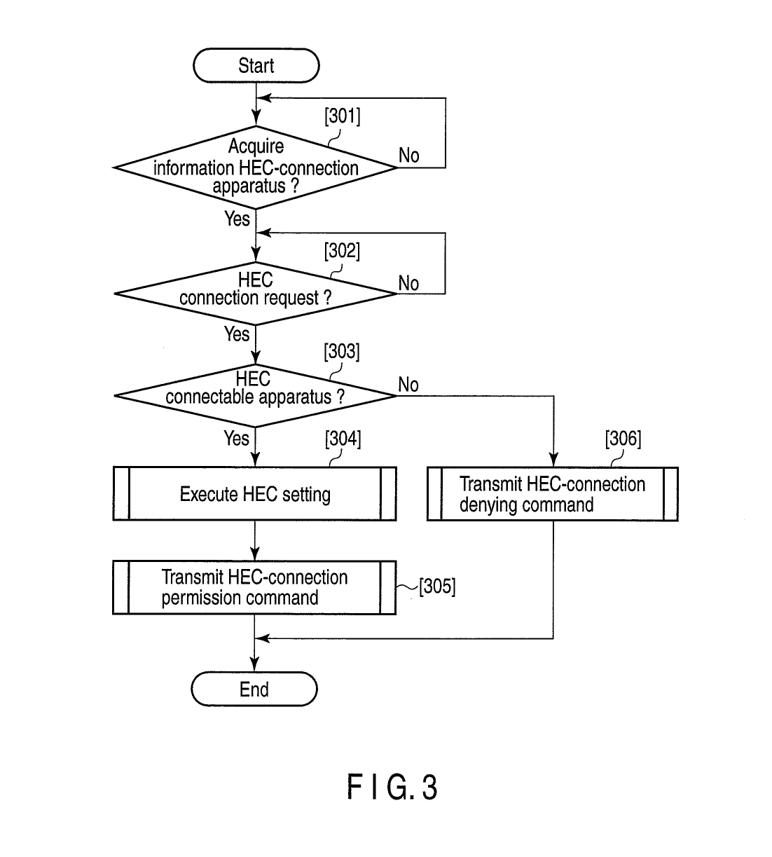

FIG. 3 shows the flow of the above mentioned [a] to [c] described in FIGS. 2A, 2B, 2C and 2D. Specifically, the flow includes the following processes [301] to [306]. One is a process of acquiring information of a HEC-connection apparatus [301]. Another is a process of making a HEC-connection request [302]. Another is a process of determining whether or not a repeater apparatus is an apparatus, which is HEC-connectable [303]. Another is a process of executing a HEC setting when a repeater apparatus is an apparatus, which is HEC-connectable [303-YES] [304]. Another is a process of transmitting a HEC-connection permission command [305]. Moreover, when a repeater apparatus is not an apparatus, which is HEC-connectable [303-NO], a process of transmitting a HEC-connection denying command [306] is included, of course.

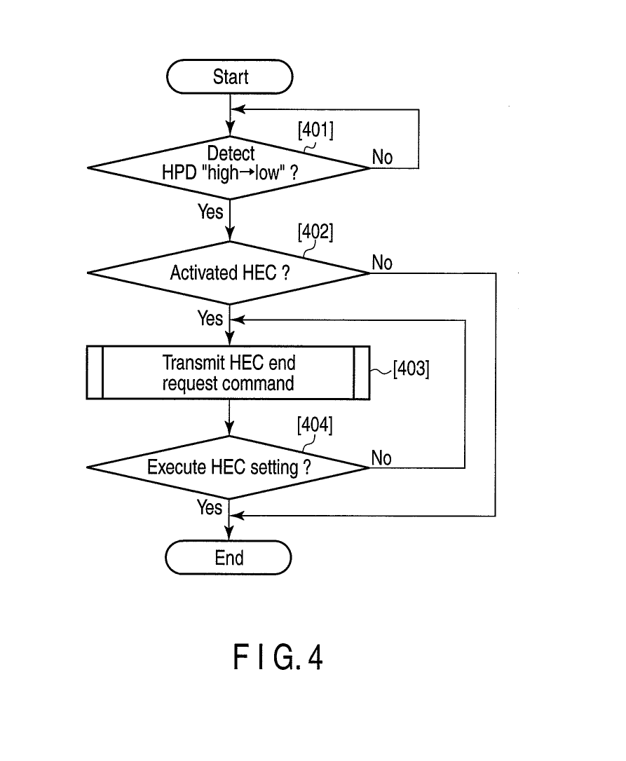

FIG. 4 shows the flow when active HEC described in FIGS. 2A, 2B, 2C and 2D (detecting that first and second repeater apparatus (B) 101 and (C) 201 interposed between the first source apparatus (D) 301 and the sink apparatus (A)1 are an apparatus, which is HEC-connectable). The flow includes the following processes [401] to [404]. Specifically, one is a process that the first source apparatus (D) 301 detects that a hot plug detected (HPD) signal of an HDMI cable changes from a high state to a low state <<H→L>> [401]. Another is a process of confirming the path of an HDMI connection of an apparatus, which is set to an active state by the first source apparatus (D) 301 [402]. Another is a process of transmitting a command for deactivating an apparatus, which is set to an active state by the first source apparatus (D) 301 (ending active HEC) [403]. Another is a process of transferring to a non-HEC using state (ending HEC of all apparatuses, which are set to an active state) [404]. In this way, it is possible to turn off the power of all apparatuses, which are started according to HEC. In this case, information related to active HEC created by other apparatus held therein is abandoned.

According to this embodiment, the first source apparatus (D), that is, the recorder 301 has the following advantage. Namely, the recorder 301 accepts an activate request only from an apparatus, which is designed to securely accepts a deactivate request (deactivate command). In this way, the recorder 301 is able to turn on the power of peripherally optional apparatuses connected to HDMI or LAN, in particular, the power of a repeater apparatus.

Therefore, the sink apparatus (A) connected to the first source apparatus (D), that is, the recorder 301 via second and first repeater apparatuses (C) 201 and (B) 101 that is, the TV receiver 1 is started (main power on) and turned off (main power off) by means of the recorder 301. Namely, the power of the TV receiver 1 is controlled by means of the recorder 301. Moreover, when the main power of the TV receiver 1 is turned off (end) by the control of the recorder 301, each main power of first and second repeater apparatuses (B) 101 and (C) 201 interposed between the TV receiver 1 and the recorder 301 can be securely turned off.

As described above, the first source apparatus (D) 301 is configured to securely accept an activate request only from an apparatus, which is designed to securely accepts a deactivate request (deactivate command). In this way, if an accident such that an HDMI cable is pulled off during active HEC happens, it is possible to turn off the power of peripherally optional apparatuses connected to HDMI or LAN without waiting timeout (two minutes and twenty seconds at the maximum).

More specifically, the first source apparatus (D) 301 makes the following determination with respect to apparatuses connected between the source apparatus (self) and the sink apparatus (A) 1. Namely, the first source apparatus (D) 301 determines whether or not the foregoing connected apparatus is an apparatus, which accepts a HEC use request from the self based on information such as vender ID (vender information of CEC data and physical address. In other words, the first source apparatus (D) 301 determines that an apparatus connected between the source apparatus (self) and the sink apparatus (A) 1 is what kind of apparatus. In this way, the first source apparatus (D) 301 determines that an apparatus, which is not adaptable to a HEC use request, is out of the path of active HEC built up by the self. Moreover, for example, if a HPD signal from the HDMI output terminal changes from a high (H) state to a low (L) state, the first source apparatus (D) 301 detects the foregoing change, and then, immediately ends HEC use.

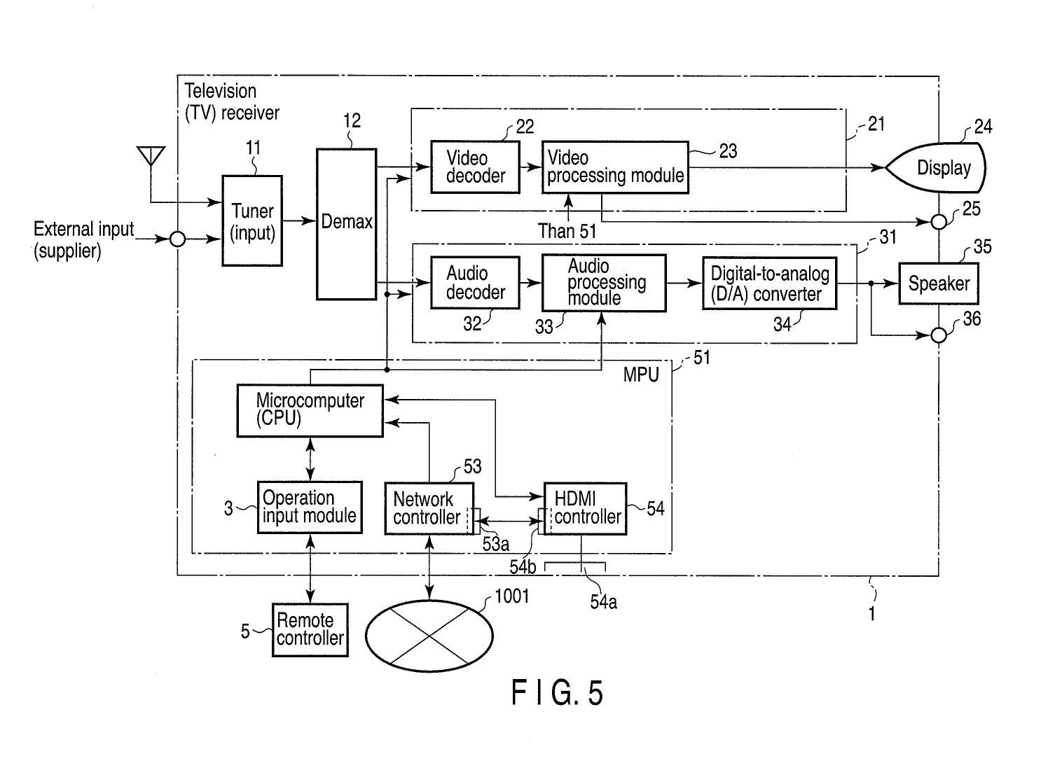

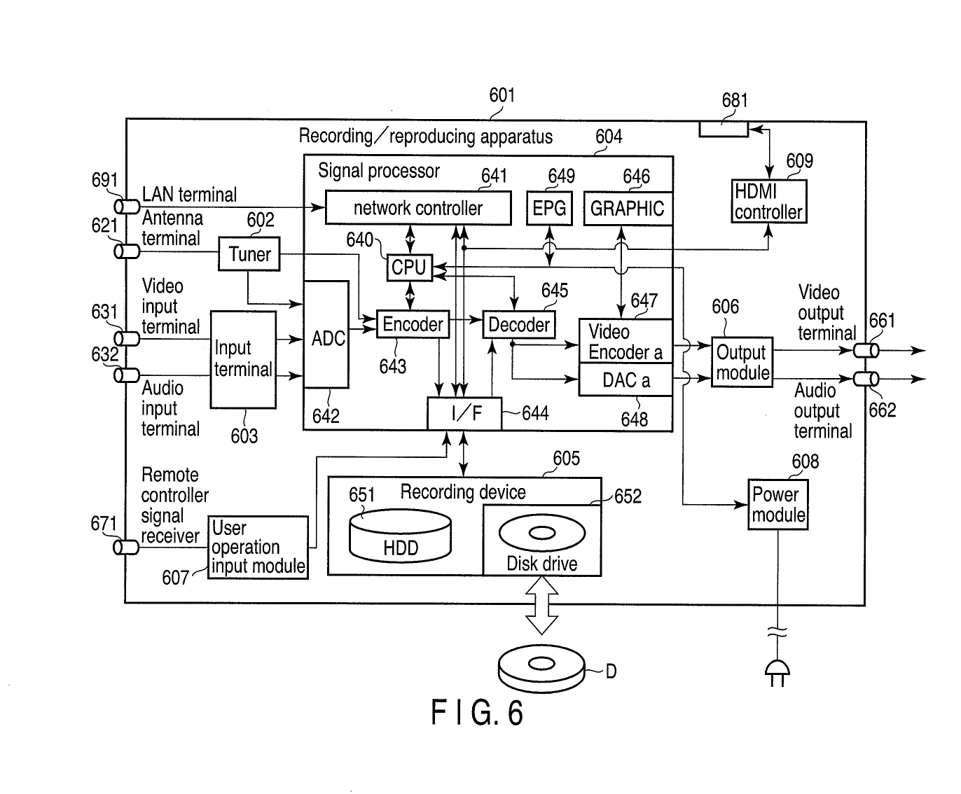

FIG. 5 is a block diagram showing one example of the configuration of the television (TV) receiver (sink apparatus (A)) shown in FIG. 1. In this case, first and second repeater apparatuses (B) and (C) are positioned between the sink apparatus (A) and the first source apparatus (D) so that active HEC are built up. FIG. 6 is a block diagram showing one example of the configuration of a recorder, which is an apparatus capable of building up active HEC via first and second repeater apparatuses (B) and (C) between the recorder and the sink apparatus (A).

For example, the TV receiver 1 receives television broadcasting supplied via a spatial wave and a wired system (transmission), and then, reproduces audio and video.

The TV receiver 1 is able to receive program of the digital broadcasting, i.e., content and is able to reproduce. Further, the TV receiver 1 is able to receive content supplied via the Internet (network) 1001.

In the TV receiver 1, a tuner 11 receiving content (program) is separated into video data and audio data by means of a demux (a separation module) 12.

The video data separated by the demux 12 is decoded by means of a video decoder 22 of a video processing block 21, and then, output as a digital video signal.

The video data decoded by the video decoder 22 is input to a video processing module 23, which is configured to make a display of a video output device. Thereafter, the video data is converted into predetermined resolution and output format, for example, interlace (i)/non-interlace (p) so that the after-stage display 24 displays the video data, and supplied to the display 24. In this case, the output of the video processing module 23 may be output to an output terminal, which is connectable with an external monitor or projector.

The audio data separated by the demux 12 is decoded by means of an audio decoder of an audio processing block 31, and then output as a digital audio signal.

The audio signal decoded by the audio decoder 32 is input to a digital-to-analog (D/A) converter 34 for obtaining an analog audio output via an audio processing module 33, which is configured so that an audio output device reproduces the audio signal.

An analog audio output from the D/A converter 34 is input to a speaker 35, for example. In this case, the output from the D/A converter 34 may be branched to an output terminal 36, which is connectable with an audiovisual (AV) amplifier.

In the TV receiver, each of the tuner 11, demux 12, the video processing block 21 and the audio processing block 31 is controlled by means of a main control block 51, and executes a predetermined operation.

The main control block (main processing unit [MPU]) 51 includes a central processing unit (CPU) or a microcomputer. The MPU 51 includes a memory unit 52, a network (LAN) controller 53 and an HDMI controller 54, at least. Specifically, the memory unit 52 includes a ROM for holding an operation program and a RAM functioning as a work memory, at least. The network (LAN) controller 53 controls a connection with the Internet 1001, that is, acquires various information from the Internet 1001 and controls access from a user with respect to the Internet 1001. The HDMI controller 54 controls an exchange of a data/control signal via Ethernet (registered trademark) conforming to HDMI version 1.4.

The HDMI controller 54 is able to make an exchange of data and control signal between an HDMI port 54a used for a connection with an external device and an HDMI port 53a of the LAN (network) controller 53. In this case, the HDMI controller 54 includes an HDMI port 54b, which can build up the active HEC according to HDMI version 1.4. Moreover, an exchange of control signal and data between the HDMI port 54b of the HDMI controller 54 and the HDMI port 53a of the LAN controller 53 is controlled by means of the MPU 51 or a sub-controller 55 connected to the MPU 51.

The MPU 51 is connected with an operation input module 3, which accepts a control input from a user.

The operation input module 3 includes a channel key (button), a power switch for turning on and off the power or a receiver unit, at least. Specifically, the channel key specifies a channel selected by the tuner (input unit) 11. The receiver unit accepts instructions and control input from a remote controller. In addition, the MPU 51 may be connected with a key operation input unit (keyboard), which inputs characters and symbols or numerals.

FIG. 6 is a block diagram showing one example of the configuration of a recorder usable as the first source apparatus (D) in the HDMI connection shown in FIG. 1.

In FIG. 6, a recorder 601 connected to a sink apparatus (TV receiver 1) via an active HEC includes a tuner 602, an input circuit 603, a digital signal processor (DSP) 604 and a recording device 605, at least. Further, the recorder 601 includes an output module 606, a user operation input module (remote controller signal receiver) 607, a power unit and an HDMI controller 609, at least. In this case, the HDMI controller 609 is connected with a network controller (LAN controller) 641. The network controller (LAN controller) 641 controls a connection with the Internet 1001, that is, controls acquisition of various information from the Internet 1001 and access from a user with respect to the Internet 1001. Further, the HDMI controller 609 is able to build up an active HEC in addition to an exchange of data/control signal via Ethernet conforming to HDMI version 1.4 with a LAN controller (network controller) 641.

The tuner 602 selects a channel for broadcasting a recording target program via an antenna connected to an antenna terminal 621 or an optical cable.

The input terminal 603 receives an audio (sound) signal input through the audio input terminal 632 and video (moving picture) signal input through the video input terminal 631.

The DSP 604 includes a main controller (CPU) 640, a network controller 641, an analog-to-digital converter (ADC) 642, an encoder 643, an interface 644, a decoder 645, and a user interface graphic processing unit (GUI) 646, at least. Further, the DSO 604 includes a video encoder (video output processing unit) 647, a digital-to-analog converter (DAC [audio decoder]) 648 and an electronic program guide (EPG) processing unit 649, at least. In this case, the interface 644 is connected with the HDMI controller 609. The HDMI controller 609 is connected with the network controller 641, and thereby, can provide the HDMI-HEC (active HEC).

The main controller (CPU) 640 controls the operation of the various elements and the power on/off of a main power (except internal control secondary circuit) of the power supply 608.

The network controller 641 receives a program having a stream format supplied from an external network via a LAN terminal 691. In this case, the LAN terminal 691 is connected with a relatively small-scale network (home local area network [LAN]) installed in the identical building or a home server (mass storage) and a connection network. For example, the LAN terminal 691 is connected with an external network via a home server. Moreover, preferably, the home LAN or network is conforming to the Digital Living Network Alliance (DLNA) (registered trademark) standard.

The analog-to-digital converter (ADC) 642 converts input analog video signal and audio signal into a digital signal, and then, inputs the digital signal to the encoder 643. In this case, if the tuner 602 receives digital broadcasting, an output of the tuner 602 is intactly input to the encoder 643, of course.

The encoder 643 converts (encodes) the input analog signal (video/audio) into the digital signal. For example, compression conforming to Moving Picture Experts Group (MPEG) 2 or MPEG-4 (H. 264-AVC) is executed.

The interface 644 is used for a data exchange with the recording device 605 or for an input of a control signal from the remote controller signal receiver 607.

The HDMI controller 609 is connected with the network controller (LAN controller) 641. For example, the HDMI controller 609 is able to build up an active HEC in a state that first and second repeater apparatuses (B) 101 and (c) 201 are interposed between the TV receiver 1 shown in FIG. 1 and the apparatus 601. In this case, the control for building up the active HEC may be carried out by means of the main controller (CPU) 640 or the network controller 641. An HDMI terminal 681 is connected with an optional apparatus via an HDMI cable.

The decoder 645 decodes a program compressed according to MPEG-2 or MPEG-4 (H. 264-AVC).

The graphical user interface (GUI) processing unit 646 outputs a GUI screen for display on an externally connected monitor to a video output terminal 661.

The video encoder (video output processing unit) 647 synthesizes a video signal and a GUI screen display output from the GUI processing unit 646 as the necessity arises. Thereafter, the video encoder 647 outputs an output video signal to the output module 606 so that the monitor connected to a video output terminal 661 displays the video signal.

The digital-to-analog converter (DAC [audio decoder]) 648 outputs an audio signal to the output module 606 so that an external speaker connected to an audio output terminal 662 reproduces the audio signal.

The EPG processing unit 649 acquires an EPG data transmitted together with a program in BS digital broadcasting or terrestrial digital broadcasting or an EPG data externally acquirable via the LAN terminal 691. For example, the GUI processing unit 646 holds date, time, channel and program length data for displaying a program table in program reservation. In this case, the acquired EPG data is stored in a memory device (not shown) or in a predetermined area of a hard disk drive (HDD) 651.

The recording device 605 includes a hard disk drive 651 or a disk drive 652. The recording device 605 records a program with respect to a hard disk (HD) of the HDD 651 or to an optical disk D conforming to the DVD standard set to the disk drive 652. Moreover, the recording device 605 reproduces an already recorded program. In this case, for example, a program may be recorded in a semiconductor memory (memory card) in addition to the disk drive 652. Moreover, a reader/write (not shown), which reproduces an already recorded program, may be prepared.

The output module 606 outputs a video signal from the video encoder 647 and an audio signal from the DAC 648 to a reproducer connected to the video output terminal 661 and the audio output terminal 662, for example, to a monitor and speaker.

The remote controller signal receiver 607 inputs a user operation input accepted by a remote controller signal receiver 671 to the main controller 640 via the interface 644.

The power supply 608 is configured so that the main power is turned off according to the control of the main controller 640. Then, when a reserved time set by a timer (not shown) comes, the power supply 608 turns on the main power so that the each element is kept at an operating state.

As described above, the HDMI controller 609 is connected with the network controller (LAN controller) 641, which controls a connection with the Internet 1001, that is, acquisition of various information from the internet 1001 and access from a user with respect to the Internet 1001. Further, the HDMI controller 609 makes an exchange of data/control signal with the LAN controller (network controller) 641 via Ethernet conforming to HDMI version 1.4. For example, an active HEC can be built up. Moreover, according to the build-up of the active HEC using the HDMI controller 609, the network controller (LAN controller) 641 connected to the HDMI controller 609 serves to interpose first and second repeater apparatuses (B) 101 and (C) 201 between the TV receiver 1 shown in FIG. 1 and the recorder 601. For example, the build-up of an active HEC may be controlled by means of the main controller (CPU) 640 or the network controller (LAN controller) 641, of course.

As described above, according to this embodiment, the source apparatus determines whether or not an apparatus connected between the source apparatus (self) and the sink apparatus accepts a HEC use request from the self based on information such as vendor ID (vendor information) acquirable from CEC data of HDMI-CEC and physical address. Namely, the source apparatus determines that an apparatus connected between the source apparatus (self) and the sink apparatus is what apparatus, and thus, determines whether or not the HEC use request is accepted. Therefore, the source apparatus determines that an apparatus, which does not accept a HEC use request, is out of the path of an active HEC built up by the self. For example, when a HPD signal of the HDMI output terminal changes from a high (H) state to a low (L) state, the source apparatus detects the change, and then, immediately ends the HEC use.

In other words, it is previously determined whether or not an apparatus accepts an externally HEC active request using HEC conforming to a bidirectional interface (HDMI version 1.4). Thus, the source apparatus incorporates an apparatus, which does not accept the HEC active request, in the path built-up by the self. In this way, it is possible to reduce the situation that the source apparatus can not turn off the power of HDMI or network (LAN)-connected optionally peripheral devices. Therefore, this serves to prevent a disadvantage with respect to the user.

In particular, second and first repeater apparatuses (C) 201 and (B) 101 are interposed between the first source apparatus (D), that is, the recorder 301 and the sink apparatus connected to the recorder 301, that is, the TV receiver 1. The start (main power on) and end (main power off) of the recorder 301 are controlled by the recorder 301. Moreover, when the main power of the TV receiver 1 is turned off (ends) according to the control of the recorder 301, the main power of first and second repeater apparatuses (B) 101 and (C) 201 interposed between the recorder 301 and the TV receiver 1 is securely turned off.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording/reproducing apparatus comprising:
a network controller configured to acquire at least one of a program and data via a network;
a signal processing module configured to transmit and receive at least one of the program and the data, as well as a control signal using bidirectional communication; and
a determination module configured to determine whether each of a connected apparatus and an external apparatus are capable of turning off in response to a power-off instruction from the signal processing module, the signal processing module being connected to the external device via an apparatus connected by a bidirectional interface, and the determination module further configured to provide a result of the determination.

2. The apparatus of claim 1, wherein the determination module is further configured to determine whether the apparatus connected to the signal processing module and the external apparatus connected via the connected apparatus securely accept the power-off instruction based on information associated with each apparatus.

3. The apparatus of claim 2, wherein the determination module is configured not to provide the result of the determination if the determination module can not make a determination with respect to at least one of the apparatus connected to the signal processing unit and the external apparatus connected via the connected apparatus, which securely accepts the power-off instruction.

4. A method of controlling an apparatus, the method comprising:
acquiring information associated with each of a video display apparatus, a recording/reproducing apparatus, and an apparatus connected between the video display apparatus and the recording/reproducing apparatus via a bidirectional communication interface;
determining, in response to an HDMI Ethernet Channel (HEC) request, whether each apparatus is HEC capable based on the acquired information associated with each apparatus; and
transmitting a report identifying a non-HEC capable apparatus to a second apparatus that is not HEC capable.

5. A method of controlling an apparatus, the method comprising:
acquiring information associated with each of a video display apparatus, a recording/reproducing apparatus, and an apparatus connected between the video display apparatus and the recording/reproducing apparatus via a bidirectional interface;
determining, in response to an HDMI Ethernet Channel (HEC) request, whether each apparatus is HEC capable based on the acquired information associated with each apparatus with respect to each apparatus; and
transmitting a report identifying the capability of each apparatus to a second apparatus that is not HEC capable.

6. The method of claim 5, further comprising activating an HEC mode for each of the video display apparatus, the recording/reproducing apparatus, and the apparatus connected between the video display apparatus and the recording/reproducing apparatus in response to each apparatus reporting as HEC capable.

7. The method of claim 6, further comprising deactivating HEC mode in response to detecting a change to a hot plug detect (HPD) signal.
